(19) United States
(12) Patent Application Publication
(10) Pub. No.: US 2014/0189298 A1
(43) Pub. Date: Jul. 3, 2014

(54) CONFIGURABLE RING NETWORK

(71) Applicants: Teresa Morrison, Fort Collins, CO (US); Scott A. Krig, Folsom, CA (US)

(72) Inventors: Teresa Morrison, Fort Collins, CO (US); Scott A. Krig, Folsom, CA (US)

(21) Appl. No.: 13/727,795

(22) Filed: Dec. 27, 2012

(51) Int. Cl. G06F 15/76

(52) U.S. Cl. CPC G06F 15/76
USPC 712/30

(57) ABSTRACT

A apparatus and computing device for providing a configurable ring network are provided herein. The apparatus includes logic to configure a ring processor for each of a plurality of processing elements, and logic to network each ring processor, wherein each ring processor communicates with other ring processors using a set of commands.

### TECHNICAL FIELD

This disclosure relates generally to computing architectures. More specifically, the disclosure relates to a configurable ring network to that enables parallel operation of a plurality of pipelines.

### BACKGROUND ART

Current computing devices are typically designed for general use cases. For example, current computing systems include at least one central processing unit (CPU) that is developed for a variety of instruction sets. Some computing systems may also include a graphics processing unit (GPU). The GPU is generally specialized for processing graphics workloads that benefit from processing large blocks of data in parallel. Both CPUs and GPUs include dedicated circuitry to perform arithmetic and logical operations, which may be referred to as an arithmetic and logic unit (ALU). The processing cores of both CPUs and GPUs are fixed in size and identical to the other cores of the respective processor. When embodied in a system on a chip (SOC), the SOC may include shared memory for both the CPU and GPU that can communicate with other SOCs. These SOCs also may have fixed function hardware capability beyond just graphics. Each fixed function hardware unit may be considered a specialized processor. The processing cores of current CPUs, GPUs, and SOCs are powered on, even when not in use.

### BRIEF DESCRIPTION OF THE DRAWINGS

The following detailed description may be better understood by referencing the accompanying drawings, which contain specific examples of numerous objects and features of the disclosed subject matter.

FIG. 1A is a block diagram of a computing device that may be used to provide a configurable ring network, in accordance with embodiments;

FIG. 1B is a block diagram of a display device, in accordance with embodiments;

FIG. 1C is a block diagram of a printing device, in accordance with embodiments;

FIG. 2 is a diagram of a scalable compute fabric, in accordance with embodiments of the present invention;

FIG. 3 is a diagram illustrating a configurable ring network, in accordance with embodiments;

FIG. 4 is a diagram illustrating a configurable ring network, in accordance with embodiments;

FIG. 5 is a diagram illustrating the communication exchange when performing an 8 point discrete Fourier transform (DFT), in accordance with embodiments; and

FIG. 6 is a process flow diagram of a method for a configurable ring network, in accordance with embodiments.

### DESCRIPTION OF THE EMBODIMENTS

As discussed above, the processing cores used in current computing systems are fixed in size and identical to the other cores of their respective processor, whether it is a CPU, GPU, or other specialized processor. Furthermore, the various processing cores are in an active, powered on state, even when not in use. Embodiments of the present techniques provide a configurable ring network that enables a plurality of pipelines in a scalable compute fabric to operate in parallel. Additionally, embodiments provide a configurable ring network with ring processors that communicate using a ring protocol. The ring protocol is a set of commands that enables the transfer of data between the pipelines of the scalable compute fabric. Furthermore, each pipeline and the corresponding ring processor may be powered off when not in use. In embodiments, a common pool of single instruction multiple data (SIMD) resources may be dynamically configured to process a graphics workload. For example, during motion estimation, a pipeline of various SIMD components could be configured to perform motion estimation. Pipelining the system results in a flexible technique to achieve desired power and performance targets for multiple simultaneous workloads. Additionally, the pipeline increases performance due to the system architecture enabling the data to remain cached and while using efficient interconnect that is dynamically configurable. Other compute elements, memory resources, logic resources, software resources, and interconnect resources may be controlled using any of the techniques presently described.

As used herein, active refers to a state that consumes power and is “on,” while inactive refers to a state that does not generate power and is “off.” Additionally, a low power state is a power state between “on” and “off.” A high power state may also be used in a burst mode where the clock speed and voltage levels are increased for short bursts of time to achieve higher performance. As used herein, performance includes any measurable quantity that indicates a capability of the system. For example, an increase data throughput of a processor can indicate higher performance.

Compute applications which may be implemented using a configurable ring network include, but are not limited to, image processing, print imaging, display imaging, signal processing, computer graphics, media and audio processing, data mining, video analytics, and numerical processing. The ring network consists of a ring network protocol that includes set of commands or high level instructions which are used by a set of ring network processors or ring network controllers. The ring network processors are connected or coupled to each compute resource including but not limited to a CPU, GPU, memory controllers, logic blocks, specialized processors, or communications devices. Thus, each compute resource may communicate via the ring network protocol across a set of replicated ring network processors. The ring network processors understand the ring network protocol and enable for processing resources to effectively communicate across the ring network. This effective communication enables the efficient performance of applications and systems using the ring network.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine, e.g., a computer. For example, a machine-readable medium may include read only memory (ROM), random access memory (RAM), magnetic disk storage media, optical storage media, flash memory devices, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the inventions. The various appearances of “an embodiment,” “one embodiment,” or “some embodiments” are not necessarily all referring to the same embodiments. Elements or aspects from an embodiment can be combined with elements or aspects of another embodiment.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

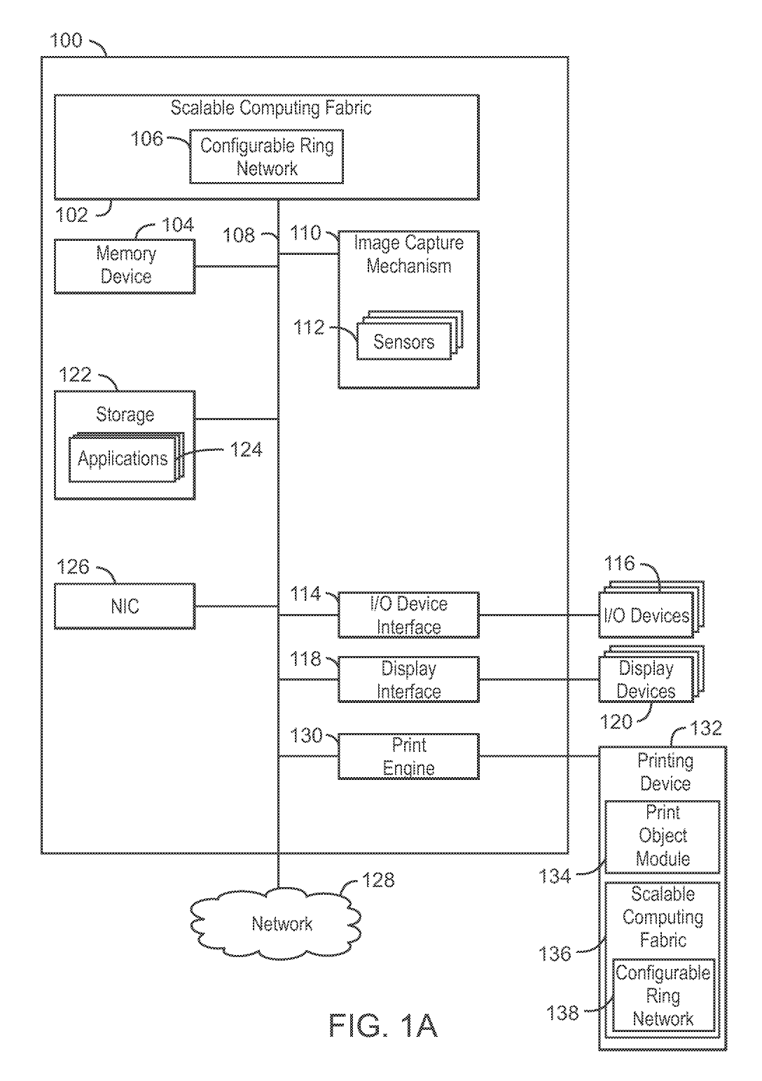

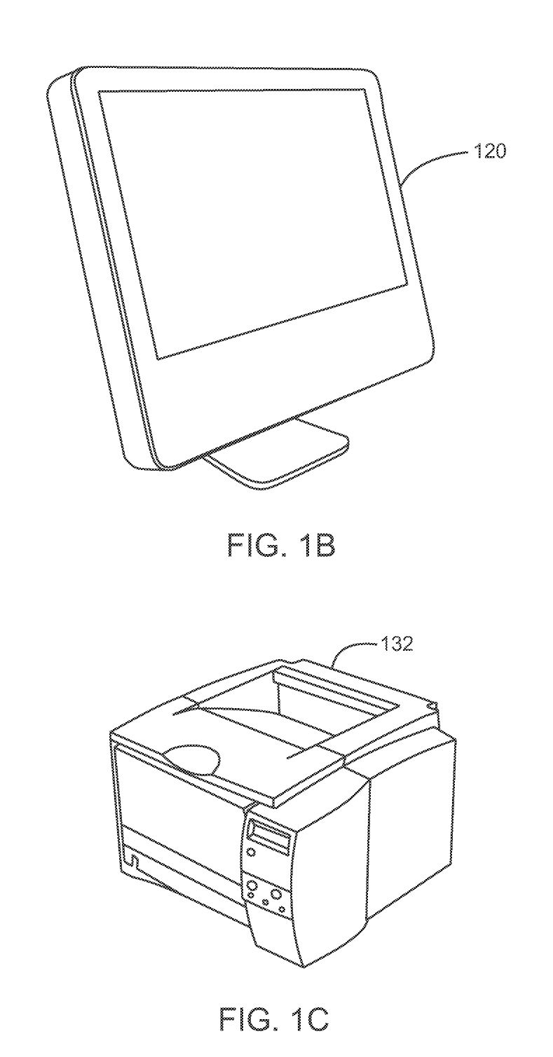

FIG. 1 is a block diagram of a computing device 100 that may be used to provide a configurable ring network, in accordance with embodiments. The computing device 100 may be, for example, a laptop computer, desktop computer, tablet computer, mobile device, or server, among others. The computing device 100 may include a scalable compute fabric 102 that is configured to execute stored instructions, as well as a memory device 104 that stores instructions that are executable by the scalable compute fabric 102. Moreover, the scalable compute fabric 102 includes a configurable ring network 106. In some embodiments, an application programming interface (API) may be used to configure the scalable compute fabric 102 and the configurable ring network 106 at runtime. Additionally, in some embodiments, the scalable compute fabric 102 and configurable ring network 106 may be pre-configured at boot time. In this manner, the computing device 100 can recognize the hardware capabilities of the scalable compute fabric 102 and the configurable ring network 106. Accordingly, the configurable ring network 106 may be preconfigured using a basic input/output system (BIOS). For example, when the computing device 100 is powered on, the BIOS that is ran during the booting procedure can identify the configurable ring network 106, including the various components processing elements of the computing device 100. The BIOS can then pre-configure the configurable ring network 106. In embodiments, the configurable ring network 106 may be reconfigured as necessary after the pre-configuration.

The memory device 104 may be a component of the scalable compute fabric 102. The scalable compute fabric 102 may be coupled to the memory device 104 by a bus 108 and be configured to perform any operations traditionally performed by a central processing unit (CPU). Further, the scalable compute fabric 102 may be configured to perform any number of graphics operations traditionally performed by a graphics processing unit (GPU). For example, the scalable compute fabric 102 may be configured to render or manipulate graphics images, graphics frames, videos, or the like, to be displayed to a user of the computing device 100.

The scalable compute fabric 102 includes, but is not limited to, several processing, memory, logical, software, communications, specialized processors and interconnect resources that can be configured and reconfigured into various processing pipelines. A pipeline is a set of resources that are grouped together to perform a specific processing task. The pipelines of the scalable compute fabric 102 may be configured to execute a set of instructions at runtime, based on the size and type of the instructions, or multiplexed to execute parallel sets of instructions. In embodiments, an application programming interface (API) may be called at runtime in order to configure a processing pipeline for a particular set of instructions. For example, the API may specify the creation of five SIMD processing units to process 64-bit wide instructions at the runtime of the 64-bit wide instructions. The API may also specify the bandwidth to the scalable compute fabric 102. In embodiments, the scalable compute fabric 102 implements a fast interconnect that can be dynamically configured and reconfigured along with the processing pipelines within the scalable compute fabric 102. Additionally, the fast interconnect may be a bus that connects the computing resources of the computing device 100.

Within the scalable compute fabric 102, there may be one or more ALU arrays and one or more register arrays. The ALU array may be used to perform arithmetic and logical operations on the data stored in the register array. The register array is a special purpose memory that may be used to store the data that is used as input to the ALUs, and may also store the resulting data from the operation of the ALUs. The data may be transferred between the memory device 104 and the registers. The memory device 104 can include random access memory (RAM), read only memory (ROM), flash memory, or any other suitable memory systems. For example, the memory device 104 may include dynamic random access memory (DRAM).

The scalable compute fabric includes a plurality of dynamically configurable pipelines that can process data in parallel using the configurable ring network. Each pipeline of the scalable compute fabric corresponds to a ring processor of the configurable ring network 106. The configurable ring network 106 transfers data between the various pipelines of the scalable compute fabric 102. In this manner, each pipeline of the plurality of pipelines can operate in parallel. Further, the configurable ring network 106 can increase available system power, as the data exchange for signal processing will not go out to memory. The active silicon power may also be reduced by turning off unused processing cores, and separating the GPU into separately operable execution units and fixed function hardware as determined by a ring protocol. Additionally, memory power savings from using a configurable ring network result from efficient memory management by the MIMD sequencers to lock buffers and ensure optimal bus traffic to/from memory, as discussed below.

The computing device 100 includes an image capture mechanism 110. In embodiments, the image capture mechanism 110 is a camera, stereoscopic camera, infrared sensor, or the like. The image capture mechanism may be integrated with the computing device 100 or external to the computing device 100. Additionally, the image capture mechanism 110 may be a universal serial bus (USB) camera that is coupled with the computing device 100 using a USB cable. The image capture mechanism 110 is used to capture image information. In embodiments, the image capture mechanism may be a camera device that interfaces with the scalable compute fabric 102 using an interface developed according to specifications by the Mobile Industry Processor Interface (MIPI) Camera Serial Interface (CSI) Alliance. For example, the camera serial interface may be a MIPI CSI-1 Interface, a MIPI CSI-2 Interface, or a MIPI CSI-3 Interface. Accordingly, the camera serial interface may be any camera serial interface presently developed or developed in the future. In embodiments, a camera serial interface may include a data transmission interface that is a unidirectional differential serial interface with data and clock signals. Moreover, the camera interface with a scalable compute fabric may also be any Camera Parallel Interface (CPI) presently developed or developed in the future.

The image capture mechanism 110 also includes one or more sensors 112. In embodiments, the scalable compute fabric 102 is configured as an SIMD processing unit for imaging operations. The scalable compute fabric 102 can take as input SIMD instructions from a workload and perform operations based on the instructions in parallel. The configurable ring network 102 transfers data between the various pipelines and memory stores. For example, the image capture mechanism 110 may be used to capture images for processing. The image processing workload may contain an SIMD instruction set, and the scalable compute fabric 102 may be used to process the instruction set. Typically images contain several regions that are processed in parallel. Accordingly, the configurable ring network can transfer the various regions of an image so that the scalable compute fabric can process the regions of the image in parallel.

The scalable compute fabric 102 may be connected through the bus 108 to an input/output (I/O) device interface 114 configured to connect the computing device 100 to one or more I/O devices 116. The I/O devices 116 may include, for example, a keyboard and a pointing device, wherein the pointing device may include a touchpad or a touchscreen, among others. The I/O devices 116 may be built-in components of the computing device 100, or may be devices that are externally connected to the computing device 100.

The scalable compute fabric 102 may also be linked through the bus 108 to a display interface 118 configured to connect the computing device 100 to a display device 120. The display device 120 may include a display screen that is a built-in component of the computing device 100. The display device 120 may also include a computer monitor, television, or projector, among others, that is externally connected to the computing device 100. An example of a display device is illustrated in FIG. 1B. In embodiments, the display device 120 receives data from the output of the configurable ring network 106. Also, in embodiments, the output data may be stored in a memory device, transmitted via an interconnect, or sent via a protocol to a remote system.

The computing device 100 also includes a storage device 122. The storage device 122 is a physical memory such as a hard drive, an optical drive, a thumbdrive, an array of drives, or any combinations thereof. The storage device 122 may also include remote storage drives. The storage device 122 includes any number of applications 124 that are configured to run on the computing device 100. The applications 124 may be used to implement a scalable compute fabric. Moreover, the instruction sets of the applications 124 may include, but are not limited to very long instruction words (VLIW) and single instruction multiple data (SIMD) instructions. The instruction sets may be processed using the scalable compute fabric 102 and the configurable ring network 106. The computing device 100 may also include a network interface controller (NIC) 126. The NIC 126 may be configured to connect the computing device 100 through the bus 108 to a network 128. The network 128 may be a wide area network (WAN), local area network (LAN), or the Internet, among others.

In embodiments, the scalable compute fabric can send the resulting image from a processed imaging workload to a print engine 130. The print engine 130 can send the resulting imaging workload to a printing device 132. An example of a printing device is illustrated in FIG. 1C. In embodiments, the printing device 132 receives data from the output of the configurable ring network 106. Also, in embodiments, the output data may be stored in a memory device, transmitted via an interconnect, or sent via a protocol to a remote system. The printing device 132 can include printers, fax machines, and other printing devices that can print the resulting image using a print object module 134. In embodiments, the print engine 130 may send data to the printing device 132 across the network 128. Moreover, in embodiments, the printing device 132 may include another scalable compute fabric 136 that may be used to process workloads using the printing device 132. The scalable compute fabric 136 may include a configurable ring network 138.

FIG. 1B is a block diagram of a display device 120, in accordance with embodiments. The display device 120 may display images in two dimensions (2D), three dimensions (3D), color scale, gray scale, or any combination thereof. Further, the image display formats may include formats such as R8, B8, G8, A8, or any combination thereof. Additionally, the image formats may have different precisions, such as integer or float.

FIG. 1C is a block diagram of a printing device 132, in accordance with embodiments. The printing device 132 may print images in 2D, 3D, color scale, gray scale, or any combination thereof.

It is to be understood that the block diagrams of FIGS. 1A, 1B, and 1C are not intended to indicate that the computing system 100 is to include all of the components shown in FIG. 1A, 1B, or 1C. Rather, the computing system 100 can include fewer or additional components not illustrated in FIG. 1A, 1B, or 1C (e.g., sensors, power management integrated circuits, additional network interfaces, etc.).

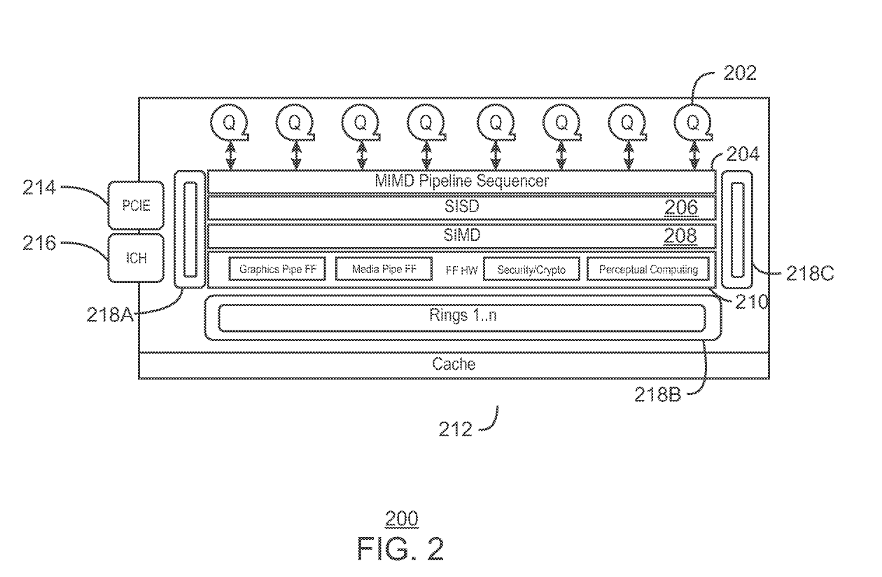

FIG. 2 is a diagram of a scalable compute fabric 200, in accordance with embodiments of the present invention. The scalable compute fabric 200 may be, for example, the scalable compute fabric 102 (FIG. 1). The scalable compute fabric 200 may also be a scalable compute fabric that is a component of a printing device, such as printing device 136 (FIG. 1).

The scalable compute fabric 200 includes one or more instruction queues 202. The instruction queues 202 include instructions from a workflow that is to be processed. The instructions are provided to one or more multiple instruction multiple data (MIMD) sequencer pipeline controllers 204 from the instruction queues 202. The MIMD pipeline sequencer controllers 204 are used to assemble one or more single data (SISD) processing cores 206, one or more SIMD processing units 208, one or more fixed function hardware units 210, or any combination thereof, into pipelines based on incoming instructions from the instruction queues 202. The SISD processing cores 206 execute the particular machine code for each processing core of the SISD 206. In embodiments, the SISD processing cores 206 may be Intel Architecture (IA) CPU Cores or hyperthreads. The SISD processing cores 206 may execute the native data types, instructions, registers, addressing modes, memory architecture, and interrupt handling specified by machine code send to the SISD processing cores 206. In embodiments, the scalable compute fabric can accept commands and data from shared memory blocks, interconnects, or via a protocol stream from a remote system. Further, multiple scalable compute fabric pipelines may be dynamically configured and simultaneously operational at run time.

Each SIMD processing unit 208 includes slices of SIMD processing resources. A slice refers to a set or grouping of lanes, where each lane includes at least one arithmetic and logical unit (ALU) and at least one register. Accordingly, the SIMD processing units 208 include an ALU array and a register array. The ALU array may be used to perform arithmetic and logical operations on the data stored in the register array. The register array is a special purpose memory that may be used to store the data that is used as input to the ALU array, and may also store the resulting data from the operation of the ALU array. The register array may be a component of a shared memory that also includes shared context of machine (CTX) data. The shared CTX data may store machine contexts and associated data, such as program counters, register settings, clock frequencies, voltage levels, and all other machine state data.

Each of the SIMD processing units 208 may be configured to be a different width, depending on the size and type of the workload to be processed. In this manner, the width of each SIMD processing unit is based on the particular problem being addressed in each piece of software run on the computer. The width of each SIMD processing unit 208 is the number of lanes in each slice. Each SIMD unit may be powered on or off, depending on if the processor is active or inactive. Inactivity may be determined by a controller monitoring the ALUs, and the ALUs that have been idle for more than a predetermined amount of clock cycles may be turned off. Alternatively, a program counter could be used to determine which ALUs could be powered off.

The fixed function hardware 210 may be represented in the scalable compute fabric 200. For example, the fixed function hardware may include graphics, display, media, security, specialized processors or perceptual computing units. In embodiments, the fixed function hardware may be implemented using resources of the scalable compute fabric. In this manner, the fixed function hardware may be replaced by other hardware that has either lower power or more efficient computation. The fixed function hardware units within the scalable compute fabric 200 may be dynamically locked, shared, and assigned into pipelines. For example, encoding a media workload typically includes, among other things, performing motion estimation. When a two dimensional (2D) video is encoded, a motion estimation search may be performed on each frame of the video in order to determine the motion vectors for each frame. Motion estimation is a technique in which the movement of objects in a sequence of frames is analyzed to obtain vectors that represent the estimated motion of the object between frames. Through motion estimation, the encoded media file includes the parts of the frame that moved without including other portions of the frame, thereby saving space in the media file and saving processing time during decoding of the media file. The frame may be divided into macroblocks, with the motion vectors represent the change in position of a macroblock between frames. The motion vectors may be determined by a pipeline configured using the scalable compute fabric 200 that includes a media fixed function unit. Additionally, the fixed function hardware 210 may also be hardware that calculates general image processing. For example, the fixed function hardware may be a filter for image noise reduction, such as the Sobel or morphological operations. By having flexible combinations using the fixed function hardware, the image can be processed in a tiled manner, such that the specialized processors can be interconnected and operate in parallel.

Memory resources within the scalable compute fabric 200 may be locked using dynamically configured pipelines. For example, a cache 212 may be included in the scalable compute fabric 200 to store data. Although one cache is shown, any number of caches may be included within the scalable compute fabric 200. For example, the scalable compute fabric may include a level 1 (L1) cache, a level 2 (L2) cache, and a level 3 (L3) cache.

A Peripheral Component Interconnect Express (PCIE) bus 214 and an Input/Output Controller Hub (ICH) 216 may provide input/output to the scalable compute fabric 200. The scalable compute fabric 200 also includes a configurable ring network that includes a ring network 218A, ring network 218B, and ring network 218C. The ring network 218A enables the PCIE bus 214 and the IOH 216 to send data to the multiple instruction MIMD sequencer pipeline controllers 204, the SISD processing cores 206, the SIMD processing units 208, and the fixed function hardware 210. As discussed above, the ring network 206B enables data to be passed directly from one fixed function hardware unit to another fixed function hardware unit. The ring network 206C enables data to be passed directly between the MIMD sequencer pipeline controllers 208, the SISD processing cores 210, the SIMD processing units 212, and the fixed function hardware 214. Although three ring networks are shown, the scalable compute fabric may include any number of ring networks. Further, the ring networks may be configured and reconfigured based on the instruction queues.

In embodiments, the scalable compute fabric with a configurable ring network may be used in a printing device, such as the printing device 132. For example, the printing device may include a scanning module that can scan documents. The printing device may convert the scanned documents to various file formats, such as a PDF file format. The printing device may also be used to enhance the scanned document or alter images within the scanned document. Accordingly, the scalable compute fabric a configurable ring network enables the configuration of a pipeline that can perform the various tasks assigned to the printer, including, but not limited to scanning, file format conversion, enhancements, and image alterations. The ring network may be used to stream, spool, or process the image.

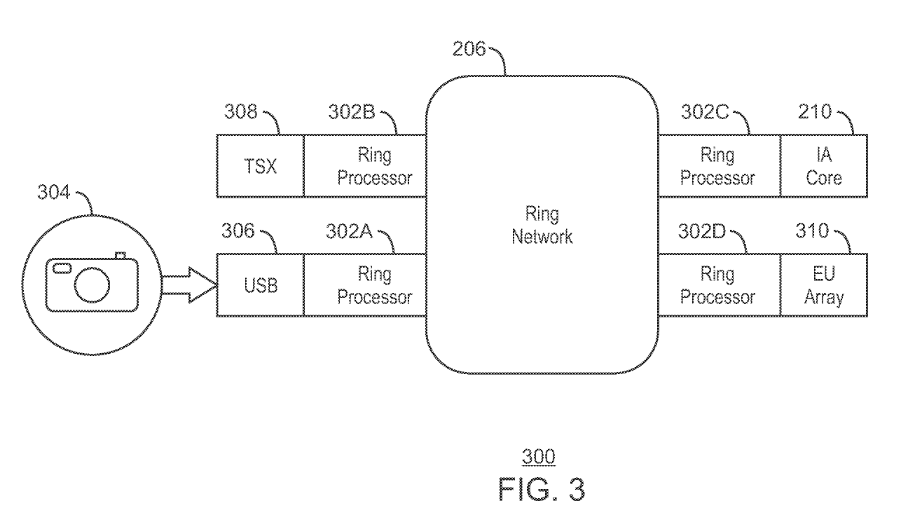

FIG. 3 is a diagram 300 illustrating a configurable ring network 206, in accordance with embodiments. The configurable ring network 206 includes a ring processor 302A, a ring processor 302B, a ring processor 302C, and a ring processor 302D. Each ring processor may be used to coordinate the transfer of data between other ring processors of the ring network 206.

The diagram 300 includes a camera input 304. The camera input 304 may be received from an input capture mechanism, such as the image capture mechanism 110 (FIG. 1). A host universal serial bus (USB) 306 may carry data from the camera input 304 to the ring processor 302A. The ring processor 302A may then coordinate the transfer of the camera input 304 data to ring processor 302B. The camera input 304 can be either a visual or a depth based (infrared) camera.

The ring processor 302B corresponds to a texture sample pipeline 308. The texture sample pipeline 308 may then process data from the camera input 304 data. The ring processor 302C may also send the camera input 304 data to the ring processor 302C in order to be processed by a processing core that is a component of the SISD 210. Further, the ring processor 302D may coordinate receiving data to be processed by an execution unit array 310.

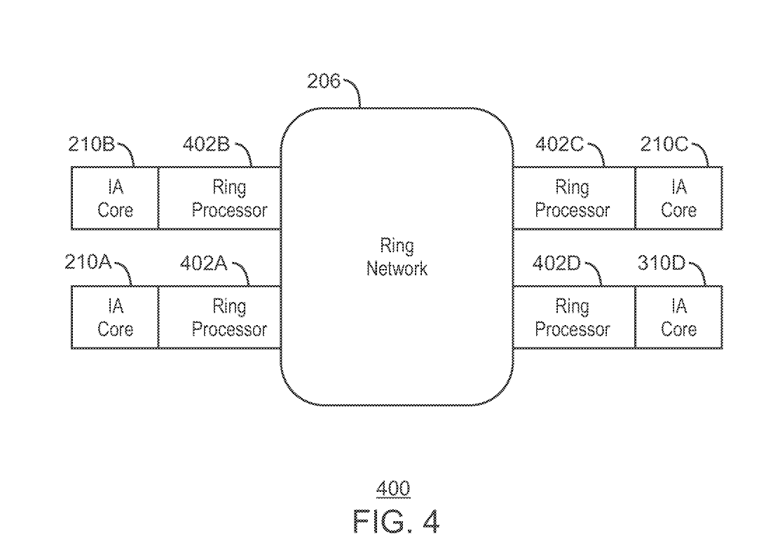

FIG. 4 is a diagram illustrating a configurable ring network 206, in accordance with embodiments. In FIG. 4, the configurable ring network 206 includes four ring processors 402A-402D. The ring processors 402A-402D each correspond to a processing core 210A-210D. In embodiments, the ring network 206 of FIG. 3 and the ring network 206 of FIG. 4 are integrated into the same computing device, such as the computing device 100 described above. In embodiments, the processing core 210 may be an Intel® Architecture (IA) processor or similar.

In embodiments, the ring processors may communicate using one or more protocol commands. Table 1 illustrates a list of exemplary commands.

TABLE 1

| Protocol | | |
|---|---|---|
| command Each | | |
| command has: | | |
| CMD ID | | |
| PROCESSOR ID | | |
| (sender/receiver) | | |
| Timestamp | | |
| Sequence number | Parameters | Description |
| Reserve_time_request | Time in uS | Instructs a processor to reserve time |
| Reserve_time_response | Abs time when | Response is time when available |
| | available | |
| Set_Clock_Frequency_request | Freq hz | Desired clock frequency |
| Set_Clock_Frequency_request | Freq hz or NULL | |
| Set_Power_State_Request | C0, C1 . . . etc. | Desired power state |
| Set_Power_State_Response | C0, C1 . . . or NULL | Response is NULL if error |
| Set_Power_Budget_request | Power in mw | Budget for power, each Processor |
| Set_Power_Budget_response | Mw or NULL if error | measures their own power from start of |
| | | processing each work item |
| Receive_Data_Request | Addr, type, size | Send data to a processor |
| Receive_Date_Response | size\|NULL | Response is NULL if error, size if OK |
| Time_Exceeded_Request | Expected_time | Notify processor tie exceeded |
| Time_Exceeded_Response | Time to go or NULL | Response: how much time left or NULL |
| Send_Instructions_request | Addr of code, len | Send address of code for processor to get |
| Send_Instructions_response | Len\|NULL | Response: Len of code if read or NULL if |
| | | error |
| Start_processing_request | Abs time | Start processing at abs time |
| Start_processing_response | Abs time started | Response: abs time when started |
| Stop_processing_request | NULL | Stop processing |
| Stop_processing_response | Response: abs time | Response: abs time when stopped |
| | stopped | |
| Time_exceeded_interrupt | Cmd_id | Processor tells requestor that reserved |
| | | time\|exceeded |
| Power_Down_On_Wait | Time interval in uS | Tells a Processor to power itself down for a |
| | | period of time if there is no work, and then |
| | | wake to check for work |
| Power_Down_Throttle | Time interval in uS | Tells a Processor to power itself down for a |
| | | period of time to work in slices |
| Send Processing characteristics | Device request the | Indicates what types of processing |
| | interconnect e.g. Fixed | capabilities are plugged into the ring |
| | function unit or VME | communication. Once you send |
| | | characteristics, you'd get an ID back for |
| | | device that matches the needs |
| Receive processor UD | Returns ID for | Indicated an ID and/or configures the |
| | device/processor that | interconnect for communication. |
| | meets the processing | |
| | characteristic needs | |
| Ring configuration | Indicate | Allows for configuration to minimize power |
| | communication, first | versus communication speed |
| | available or nearest or | |
| | minimize power | |

Each ring processor can communicate with other ring processors using commands such as the commands of table 1. In this manner, the ring processors are linked or networked together to coordinate and schedule the transfer of data as it is processed in parallel.

Fox example, in embodiments, the configurable ring network 206 may be used for video processing. The set of ring processors 302A-302D (FIG. 3) and the set of ring processors 402A-402D can execute in parallel in order to process an image from the camera input 304 (FIG. 3). In embodiments, the camera input 304 is a USB camera.

The image may be retrieved from the camera input 304 one line at a time. Each line of image data from the camera input 304 camera data may then be processed in parallel using the configurable ring network 206. The ring processors 302 can schedule and coordinate the processing of each line of image data. The image may be sharpened in order to increase the perception of edges in the image. The image data may be sharpened in pixel-by-pixel, where each pixel is assigned a color from the red-green-blue (RGB) color space. The image may then be converted to a luminance-chrominance-chrominance color coordinate system, such as the YIQ color space. Converting the image to YIQ enables a histogram equalization to be applied to the Y channel of the YIQ representation of the image, which normalizes the brightness levels of the image. The Y component of the YIQ color space represents the luminance information, while the I and Q represent the chrominance information. Moreover, a histogram equalization is a technique in which image processing of contrast adjustment is performed using the image's histogram. If the histogram equalization directly is applied to the RGB image, the color balance of the image would be negatively altered. After histogram equalization, the image may then be converted back to the RGB color space, and the texture unit may then warp the image. The image may be distorted as it is converted from one color space to another. As a result, the image may be warped in order to match any distortion before the image is mapped onto an object.

The configurable ring network 206 may be used to perform the image processing discussed above in parallel. The host USB 306 (FIG. 3) first receives the image from camera input 304 one line at a time. The host USB 306 may reserve 33 ms of time for image processing using the processing core 210 (FIG. 3) by communicating with the corresponding ring processor 302C. The ring processor 302A may then send the image to the processing core 210 one line at a time. The ring processor 302A then sends RGB components of the image to other processing cores, such as processing core 210A, processing core 210B, processing core 210C, and processing core 210D of FIG. 4. Accordingly, the ring processor 302A will communicate with the corresponding ring processor 402A, ring processor 402B, ring processor 402C, and ring processor 402D when sending RGB components of the image to the other processing cores for RGB sharpening.

One the RGB data of the image has been sharpened, each of the processing core 210A, processing core 210B, processing core 210C, and processing core 210D sends the data back to processing core 210. Again, the coordination of the data transfer between the processing cores is controlled by the corresponding ring processors. The processing core 210 of FIG. 3 may then covert each pixel of the data to the YIQ color space. The processing core 210A then sends each pixel to the processing core 210B to perform histogram equalization. The coordination of sending the data from the processing core 210A to the processing core processing core 210B is coordinated by the respective ring processors 402A and 402B. The processing core 210B may then send the data to a texture engine 308 for warping, as coordinated by the ring processor 402B and the ring process 302B. When the warping is complete, the processing core 210 is notified of the completion. The processing core 210 may then notify the host USB 306 that image processing is complete.

In another embodiment, a signal processing algorithm uses multiple processors by transferring information between various stages of the algorithm. Refer to Equation 1, for an exemplary Discrete Fourier Transform (DFT) equation:

$$( x ( n ) ) = \frac{1}{N} {\sum }_{k = 0}^{N - 1} x ( k ) {W}_{N}^{- nk} , \\ 0 \leq n \leq N - 1 , \\ {W}_{N}^{- nk} = {e}^{\frac{- i 2 π}{N}} \qquad Eqn . 1$$

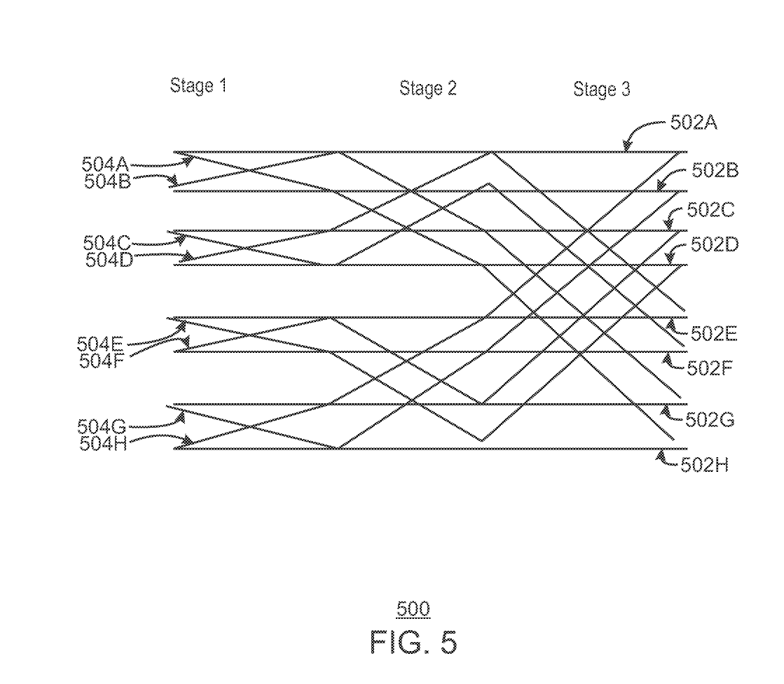

FIG. 5 is a diagram illustrating the communication exchange 500 when performing an 8 point discrete Fourier transform (DFT), in accordance with embodiments. Each horizontal line 502A-502H represents a processor, while each line 504A-504H represents information exchange between the processors. The DFT may be performed in three stages. The exchange between the processors of the three stages requires communication between different each processor, thereby enabling each stage of the DFT to be handled by the reconfigurable ring network as described below.

To process the DFT using a configurable ring network, processors 502A, the processors 502 may be grouped in pairs through using their corresponding ring processors to configure each pair to be adjacent. Accordingly, prior to stage 1, the configurable ring network 206 configures adjacent communication between four groups of processors: processor 502A and processor 502B, 502C and processor 502D, 502E and processor 502F, and 502G and processor 502H. At stage 1, a two point DFT is performed. After the two point DFT is performed, the configurable ring network may then be reconfigured to enable adjacent communication between another four groups of processors: processor 502A and processor 502C, 502G and processor 502D, 502E and processor 502H, and 502G and processor 502H. At stage 2, a two point combined DFT is performed.

After the two point combined DFT is performed, the configurable ring network may then be reconfigured to enable adjacent communication between yet another four groups of processors: processor 502A and processor 502G, 502H and processor 502B, 502C and processor 502D, and 502E and processor 502F. At stage 3, a four point combined DFT is performed. In this manner, the configurable ring network enables several processors to perform the 8 point DFT in parallel by exchanging information at various stages within the transform. As most algorithms use a different interconnect of processors, the configurable ring network is able to be dynamically configured and reconfigured as algorithms and processing needs evolve.

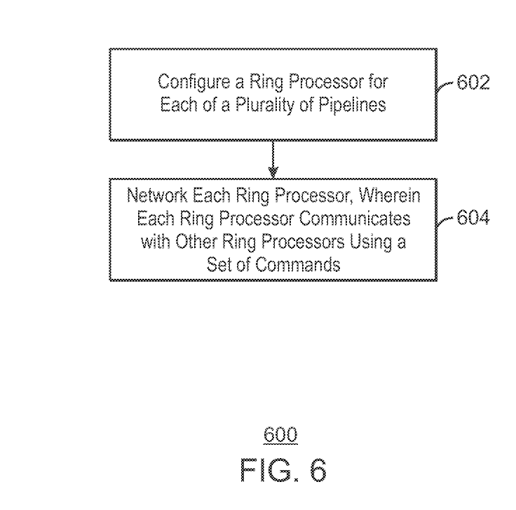

FIG. 6 is a process flow diagram of a method 600 for a configurable ring network, in accordance with embodiments. At block 604, a ring processor is configured for each of a plurality of processing elements. The processing elements include, but are not limited to, CPUs, GPUs, memory controllers, logic blocks, interconnects, communications channels, specialized processors, communication devices, or dynamically configured pipelines. The plurality of pipelines may be dynamically configured pipelines for processing a workflow. In embodiments, a processing unit of the plurality of processing elements and the corresponding ring processor is powered down when the processing unit is inactive for a predetermined amount of time. Additionally, a pipeline may include at least one or more of a processing core, an execution unit array, or any combination thereof. Moreover, the pipelines may be configured by allocating processing resources to the pipeline, reserving memory resources and bus bandwidth for the pipeline, and scheduling the workflow use of the pipeline. In embodiments, a pipeline is powered down when the pipeline is inactive for a predetermined amount of time.

At block 604, each ring processor is networked with other ring processors, wherein each ring processor communicates with other ring processors using a set of commands. The allowing processing elements to be connected dynamically and controlled via the ring network and instruction set In embodiments, the set of commands comprise a ring protocol. The ring network enables each pipeline of the plurality of pipelines to operate in parallel.

The process flow diagram of FIG. 6 is not intended to indicate that the steps of the method 600 are to be executed in any particular order, or that all of the steps of the method 600 are to be included in every case. Further, any number of additional steps may be included within the method 600 and the method 600, or any combinations thereof, depending on the specific application. For example, the printing device 132 may print an image that was previously processed using a scalable compute fabric.

### Example 1

An apparatus for providing a configurable ring network is provided herein. The apparatus includes logic to configure a ring processor for each of a plurality of processing elements, and logic to network each ring processor. Each ring processor communicates with other ring processors using a set of commands and data. The set of commands may comprise a ring protocol. Additionally, the plurality of processing elements may comprise a dynamically configured pipeline for processing a workflow. A processing unit of the plurality of processing elements and the corresponding ring processor may be powered down or powered to a lower power state when the processing unit is inactive for a predetermined amount of time. Further, the ring network may connect the plurality of elements on a system on chip (SOC). Moreover, the ring network may enable each processing element of the plurality of processing elements to operate in parallel. The ring network may be dynamically configured at runtime, and the ring network may be pre-configured using BIOS at boot time. The apparatus may be an image capture mechanism. Further, the image capture mechanism may include one or more sensors that gather image data.

### Example 2

A computing device is described herein. The computing device includes a plurality of ring processors and a plurality of processing elements. The plurality of ring processors correspond to the plurality of processing elements, and the plurality of ring processors communicate using commands and data. The commands may comprise a ring protocol. The plurality of processing elements may be a dynamically configured pipeline for processing a workflow. Additionally, the plurality of processing elements may include at least one or more of a CPU, a GPU, a memory controller, a logic block, an interconnect, a communications channel, a specialized processor, a communication device, or any combination thereof. Further, the plurality of processing elements may be implemented using a system on a chip (SOC). The plurality of elements may also be configured using a scalable computing fabric. The plurality of ring processors may comprise a ring network.

### Example 3

A printing device to print a workload is described herein. The printing device includes a ring network configured to arrange a plurality of processing elements dynamically for processing the workload. Each of the plurality of processing elements correspond to a ring processor, and the ring processors are networked. The networked ring processors communicate using a ring protocol. Additionally, the ring protocol may comprise protocol commands. Each processing element of the plurality of processing elements may include at least one or more of a CPU, a GPU, a memory controller, a logic block, an interconnect, a communications channel, a specialized processor, a communication device, or any combination thereof. Moreover, a processing element of the plurality of processing elements and the corresponding ring processor may be powered down when the pipeline is inactive for a predetermined amount of time.

In the preceding description, various aspects of the disclosed subject matter have been described. For purposes of explanation, specific numbers, systems and configurations were set forth in order to provide a thorough understanding of the subject matter. However, it is apparent to one skilled in the art having the benefit of this disclosure that the subject matter may be practiced without the specific details. In other instances, well-known features, components, or modules were omitted, simplified, combined, or split in order not to obscure the disclosed subject matter.

Various embodiments of the disclosed subject matter may be implemented in hardware, firmware, software, or combination thereof, and may be described by reference to or in conjunction with program code, such as instructions, functions, procedures, data structures, logic, application programs, design representations or formats for simulation, emulation, and fabrication of a design, which when accessed by a machine results in the machine performing tasks, defining abstract data types or low-level hardware contexts, or producing a result.

For simulations, program code may represent hardware using a hardware description language or another functional description language which essentially provides a model of how designed hardware is expected to perform. Program code may be assembly or machine language, or data that may be compiled and/or interpreted. Furthermore, it is common in the art to speak of software, in one form or another as taking an action or causing a result. Such expressions are merely a shorthand way of stating execution of program code by a processing system which causes a processor to perform an action or produce a result.

Program code may be stored in, for example, volatile and/or non-volatile memory, such as storage devices and/or an associated machine readable or machine accessible medium including solid-state memory, hard-drives, floppy-disks, optical storage, tapes, flash memory, memory sticks, digital video disks, digital versatile discs (DVDs), etc., as well as more exotic mediums such as machine-accessible biological state preserving storage. A machine readable medium may include any tangible mechanism for storing, transmitting, or receiving information in a form readable by a machine, such as antennas, optical fibers, communication interfaces, etc. Program code may be transmitted in the form of packets, serial data, parallel data, etc., and may be used in a compressed or encrypted format.

Program code may be implemented in programs executing on programmable machines such as mobile or stationary computers, personal digital assistants, set top boxes, cellular telephones and pagers, and other electronic devices, each including a processor, volatile and/or non-volatile memory readable by the processor, at least one input device and/or one or more output devices. Program code may be applied to the data entered using the input device to perform the described embodiments and to generate output information. The output information may be applied to one or more output devices. One of ordinary skill in the art may appreciate that embodiments of the disclosed subject matter can be practiced with various computer system configurations, including multiprocessor or multiple-core processor systems, minicomputers, mainframe computers, as well as pervasive or miniature computers or processors that may be embedded into virtually any device. Embodiments of the disclosed subject matter can also be practiced in distributed computing environments where tasks may be performed by remote processing devices that are linked through a communications network.

Although operations may be described as a sequential process, some of the operations may in fact be performed in parallel, concurrently, and/or in a distributed environment, and with program code stored locally and/or remotely for access by single or multi-processor machines. In addition, in some embodiments the order of operations may be rearranged without departing from the spirit of the disclosed subject matter. Program code may be used by or in conjunction with embedded controllers.

While the disclosed subject matter has been described with reference to illustrative embodiments, this description is not intended to be construed in a limiting sense. Various modifications of the illustrative embodiments, as well as other embodiments of the subject matter, which are apparent to persons skilled in the art to which the disclosed subject matter pertains are deemed to lie within the scope of the disclosed subject matter.

What is claimed is:

1. An apparatus for providing a configurable ring network, comprising:
logic to configure a ring processor for each of a plurality of processing elements;
logic to network each ring processor, wherein each ring processor communicates with other ring processors using a set of commands and data.

2. The apparatus of claim 1, wherein the set of commands comprises a ring protocol.

3. The apparatus of claim 1, wherein the plurality of processing elements comprises a dynamically configured pipeline for processing a workflow.

4. The apparatus of claim 1, wherein a processing unit of the plurality of processing elements and the corresponding ring processor is powered down or powered to a lower power state when the processing unit is inactive for a predetermined amount of time.

5. The apparatus of claim 1, wherein the ring network connects the plurality of elements on a system on chip (SOC).

6. The apparatus of claim 1, wherein the ring network enables each processing element of the plurality of processing elements to operate in parallel.

7. The apparatus of claim 1, wherein the ring network is dynamically configured at runtime.

8. The apparatus of claim 1, wherein the ring network is pre-configured using BIOs at boot time.

9. The apparatus of claim 1, wherein the apparatus is an image capture mechanism.

10. The apparatus of claim 9, wherein the image capture mechanism comprises one or more sensors that gather image data.

11. A computing device, comprising:
a plurality of ring processors; and
a plurality of processing elements, wherein the plurality of ring processors correspond to the plurality of processing elements, and the plurality of ring processors communicate using commands and data;

12. The computing device of claim 11, wherein the commands comprise a ring protocol.

13. The computing device of claim 11, wherein the plurality of processing elements is a dynamically configured pipeline for processing a workflow.

14. The computing device of claim 11, wherein the plurality of processing elements includes at least one or more of a CPU, a GPU, a memory controller, a logic block, an interconnect, a communications channel, a specialized processor, a communication device, or any combination thereof.

15. The computing device of claim 11, wherein the plurality of processing elements is implemented using a system on a chip (SOC).

16. The computing device of claim 11, wherein the plurality of processing elements is configured using a scalable computing fabric.

17. The computing device of claim 11, wherein the plurality of ring processors comprise a ring network.

18. A printing device to print a workload, comprising a ring network configured to:
arrange a plurality of processing elements dynamically for processing the workload, wherein each of the plurality of processing elements corresponding to a ring processor, and wherein the ring processors are networked.

19. The printing device of claim 18, wherein the networked ring processors communicate using a ring protocol.

20. The printing device of claim 19, wherein the ring protocol comprises protocol commands.

21. The printing device of claim 18, wherein each processing element of the plurality of processing elements includes at least one or more of a CPU, a GPU, a memory controller, a logic block, an interconnect, a communications channel, a specialized processor, a communication device, or any combination thereof.

22. The printing device of claim 18, wherein a processing element of the plurality of processing elements and the corresponding ring processor is powered down when the pipeline is inactive for a predetermined amount of time.
